(19) United States
(12) Patent Application Publication
(10) Pub. No.: US 2007/0027764 A1
(43) Pub. Date: Feb. 1, 2007

(54) Information managing apparatus, information managing method, and information managing system

(75) Inventor: Yoko Masuo, Iruma-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/486,117

(22) Filed: Jul. 14, 2006

(30) Foreign Application Priority Data
Jul. 29, 2005 (JP) 2005-220362

(51) Int. Cl. G06Q 30/00

(52) U.S. Cl. 705/14

(57) ABSTRACT

According to one embodiment, there is provided an information processing apparatus capable of delivering, to a terminal, stream data of a content which a plurality of users view in common. The apparatus includes a content viewing results storage portion to store content viewing results information indicative of temporal positions in content playback at which respective users have lastly viewed the content, and a content transmitting portion to transmit, upon a request for viewing of the content from one of the users, stream data of the content to be played back from a temporal position at which the one of the users has lastly viewed, based on the content viewing results information stored in the content viewing results storage portion.

### CROSS-REFERENCE TO RELATED APPLICATIONS

This application is based upon and claims the benefit of priority from Japanese Patent Application No. 2005-220362, filed Jul. 29, 2005, the entire contents of which are incorporated herein by reference.

### BACKGROUND

1. Field

One embodiment of the invention relates to an information managing apparatus, an information managing method and an information managing system, which allow management of users' viewing results.

2. Description of the Related Art

In recent years, there is a trend in creating a home network in a private home, so that a plurality of users can view contents (TV broadcast programs or the like) stored in a home server via terminals. The contents in the home server, which have been acquired through communication media or recording media, are generally inhibited from being copied more than once (that is, only copy once is allowed) in order to protect the copyrights. Once such a content is captured in the server, it cannot be copied in a terminal. Therefore, the server is required to satisfy demands for viewing from a plurality of users without copying the content to terminals. Further, if a user stops viewing a content at some midpoint and then requests viewing of the same content, it may be required that the viewing be restarted at the point where the viewing was stopped.

There are various techniques for managing information in a system that distributes contents to a plurality of users. For example, Jpn. Pat. Appln. KOKAI Publication No. 2002-328949 discloses that the server manages histories, such as information on the point where each user stops viewing of a content.

However, the technique disclosed in the above publication is not involved in a system in which a plurality of users view the same content. Therefore, it cannot properly deal with the requests for viewing of the content from the respective users.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of an information managing system according to an embodiment of the invention;

FIG. 2 is an exemplary diagram showing an example of a log-in screen for registered users;

FIG. 3 is an exemplary diagram showing an example of information stored in a user information database;

FIG. 4 is an exemplary diagram showing an example of information stored in a content information database;

FIG. 5 is an exemplary diagram showing an example of information stored in a content viewing results database; and

FIG. 6 is an exemplary flowchart showing operations of a server and a terminal.

### DETAILED DESCRIPTION

Various embodiments according to the invention will be described hereinafter with reference to the accompanying drawings. In general, according to one embodiment of the invention, there is provided an information processing apparatus capable of delivering, to a terminal, stream data of a content which a plurality of users view in common. The apparatus includes a content viewing results storage portion to store content viewing results information indicative of temporal positions in content playback at which respective users have lastly viewed the content, and a content transmitting portion to transmit, upon a request for viewing of the content from one of the users, stream data of the content to be played back from a temporal position at which the one of the users has lastly viewed, based on the content viewing results information stored in the content viewing results storage portion.

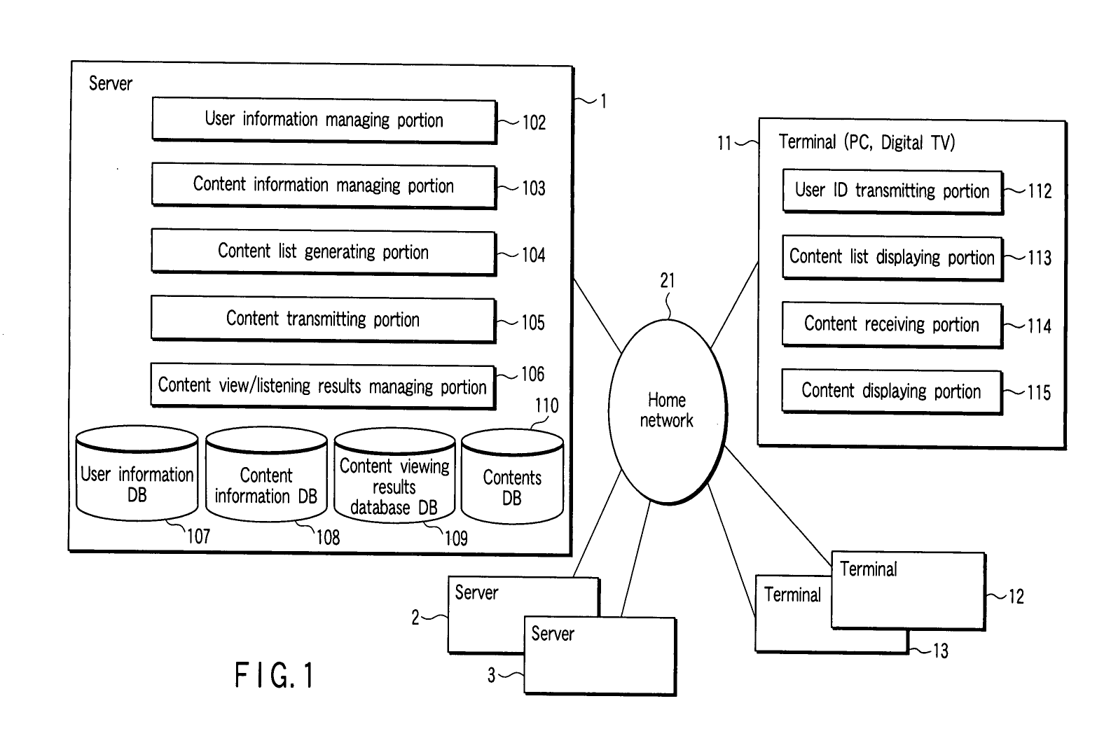

FIG. 1 is a block diagram showing a configuration of an information managing system according to the embodiment of the invention.

The information managing system of this embodiment includes a plurality of servers (information managing apparatuses) 1, 2, 3 . . . , a plurality of terminals 11, 12, 13 . . . and a home network 21. Of these elements, the servers 2, 3 . . . may be omitted.

Each of the servers 1, 2, 3 . . . is connected via the home network 21 to the terminals 11, 12, 13 . . . , which are used by a plurality of users. The server is configured to distribute contents, which the users can view in common, upon request for transmission of contents from the respective users. The contents are distributed to the users in the form of a stream. The servers 1, 2, 3 . . . correspond to, for example, a hard disk drive (HDD)/digital versatile disc (DVD) recorder that can record and play back a broadcast program acquired through a TV tuner, an HDD-equipped mobile device, etc.

It is assumed that each of the contents stored in the server 1, 2, . . . 3 is inhibited from being copied more than once (that is, only copy once is allowed) in order to protect the copyrights; and once the content is fetched in the server, it cannot be copied from the server to the terminals, but can be distributed for the purpose of viewing.

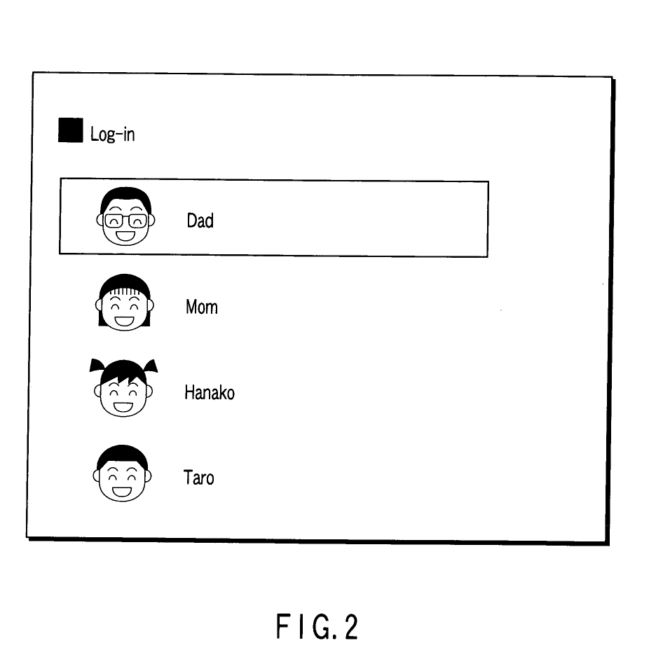

The terminals 11, 12, 13 . . . are connected to the servers 1, 2, 3 . . . through the home network 21. A plurality of users can input data in the terminals. Each terminal can display a log-in screen for the registered users, as shown in FIG. 2, a list of contents that can be viewed after the log-in. It can also send a content transmission request to the servers 1, 2, 3 . . . , and sequentially play back as a moving picture the contents transmitted in reply to the request in the form of a stream through a display device, etc. The terminals 11, 12, 13 . . . correspond to, for example, a personal computer (PC), a digital TV set having a network connecting function.

The servers 1, 2, 3 . . . have the same functions. In this specification, descriptions on the functions of the servers 2, 3 . . . are omitted and only the server 1 will be mainly described.

The server 1 has various functions, which are performed by a user information managing portion 102, a content information managing portion 103, a content list generating portion 104, a content transmitting portion 105, a content viewing results managing portion 106, etc. The server 1 also has various databases (storage portions), such as a user information database (DB) 107, a content information database (DB) 108, a content viewing results database (DB) 109, a contents database (DB) 110, etc. The server 1 alone may have these functions and databases, or each of the servers 1, 2, 3 . . . may have the same.

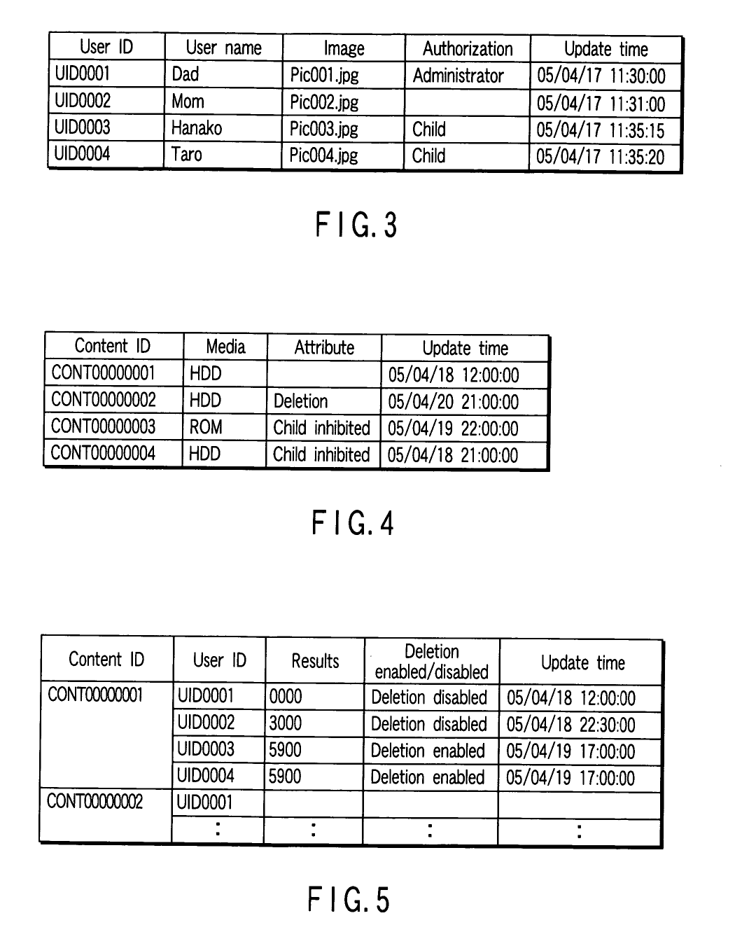

The user information DB 107 stores information relating to all users who are authorized to use this system, for example, as shown in FIG. 3. More specifically, the user information DB 107 includes various items of information on each user: such as “user ID” to identify the user; “user name” indicative of the name of the user; “image” to display the image on the screen when the user logs in to the system through the terminal; “authorization” indicative of details of the rights of the user; and “update time” indicative of the time and date when the information was updated. “Update time” information is used to determine the latest information, in the case where the servers 1, 2, 3 . . . have the same user information DB 107. It is assumed that the user information DB 107 is prestored in the present system.

The content information DB 108 stores information on contents, which the users registered in the user information DB 107 can view in common, for example, as shown in FIG. 4. More specifically, the content information DB 108 includes various items of information on each content: such as “content ID” to identify the content; “media” to identify the recording medium (e.g., an HDD, DVD, ROM or the like) storing the content; “attribute” indicative of the restriction of access to the content (e.g., inhibiting a child from viewing (parental control)); and “update time” indicative of the time and date when the information was updated. “Update time” information is used to determine the latest information, in the case where the servers 1, 2, 3 . . . have the same content information DB 108. If the content is recorded in an HDD, a record start time is applied to an initial value of “the update time”.

The content viewing results DB 109 stores, for each content, content viewing results information indicative of temporal positions in content playback at which respective users have lastly viewed the content as stream data, for example, as shown in FIG. 5. The information shown in FIG. 5 is produced on the basis of the information shown in FIG. 3 and the information shown in FIG. 4. The content viewing results DB 109 includes various items of information on each content: such as “content ID” to identify the content (the same as the content ID shown in FIG. 4); “user ID” to identify the user who is allowed to view the content; “result” indicative of to what position the user has viewed the content; “deletion enabled/disabled” indicative of whether the user permits deletion of the content; and “update time” indicative of the time and date when the “result” or “deletion enabled/disabled” information was updated. “Result” information is represented as, for example, a position on a time axis (relative time) from the beginning of the content at the time of stopping the playback. In the case of a content recorded in the DVD format, information such as presentation time stamp (PTP) may be applied to “result” (in this case, the initial value is “0”). Before the viewing, “deletion disabled” is set as “deletion enabled/disabled” information. When the user completes the viewing of the content or instructs deletion of the contents, “deletion enabled” is automatically set as “deletion enabled/disabled” information. “Update time” information is used to determine the latest information, in the case where the servers 1, 2, 3 . . . have the viewing results DB 109. If the content is recorded in an HDD, a record start time is applied to an initial value of “the update time”.

The contents DB 110 stores contents which the users registered in the user information DB 107 can view in common.

The user information managing portion 102 performs a function of managing the user information DB 107. For example, when the user requests update of user information, the user information managing portion 102 updates the corresponding information.

The content information managing portion 103 performs a function to manage the content information DB 108. For example, when the user requests update of content information, the user information managing portion 102 updates the corresponding information.

The content list generating portion 104 performs a function of generating a content list utilizing the user information DB 107, the content information DB 108, and the content viewing results DB 109. For example, it generates a list of contents that a user is allowed to view upon request by the user.

The content transmitting portion 105 performs a function of transmitting a content, which the user requests to view, from a plurality of contents stored in the contents DB 110, to the corresponding terminal. For example, the content transmitting portion 105 can transmit to the user a list of contents which the user is allowed to view, or a content selected from the list upon request by the user. In particular, when one of the users registered in the user information DB 107 requests viewing of one of the contents registered in the content information DB 108, the content transmitting portion 105 refers to content viewing results stored in the content viewing results DB 109, thereby obtaining the “results” information corresponding to the “user ID” information of the user which belongs to “content ID” of the content for which viewing is requested. Then, the content transmitting portion 105 transmits stream data of the content to be played back from a position (at which the user has lastly viewed) indicated by the “results” information. Thus, if the user has not viewed the content, he/she will view it from the beginning. If the user has viewed the content and stopped at some midpoint, he/she will view the rest of the content.

The content viewing results managing portion 106 performs a function of managing the content viewing results DB 109. For example, when the user instructs content transmission stop (content playback stop) or content deletion, the content viewing results managing portion 106 records the “results” or “deletion enabled/disabled” information in the content viewing results DB 109 upon receiving the instruction from the user and updates the information. The content viewing results managing portion 106 has a function of setting the “deletion disabled” information before viewing, and the “deletion enabled” information indicating that deletion of the content is permitted, in the case where the user has completed viewing of the content or instructed deletion of the content. The content viewing results managing portion 106 further has a function of deleting a content, in the case where the “deletion enabled/disabled” information indicates that all users who are authorized to view the content allow deletion of the content. The content viewing results managing portion 106 may be configured to have a function of causing the terminals to display information requesting the user to confirm whether to delete the content, instead of immediately deleting the content, if the user has completed viewing of the content or instructs deletion of the content.

The terminals 11, 12, 13 . . . have the same functions. In this specification, descriptions on the functions of the terminals 12, 13 . . . are omitted and only the terminal 11 will be mainly described.

The terminal 11 has various functions, which are performed by a user ID transmitting portion 112, a content list displaying portion 113, a content receiving portion 114, and a content displaying portion 115. The terminal 11 alone may have these functions, or each of the terminals 11, 12, 13 . . . may have the same.

The user ID transmitting portion 112 performs a function of transmitting a user ID input by the user to a server, and transmitting a content transmission request or content stop request operated by the user, after user authentication through the user ID has been carried out.

The content list displaying portion 113 performs a function of displaying, on the screen, information on a content list transmitted from the server side.

The content receiving portion 114 performs a function of receiving a content list and content transmitted from the server side.

The content displaying portion 115 performs a function of displaying (playing back) the content transmitted from the server side as a moving picture.

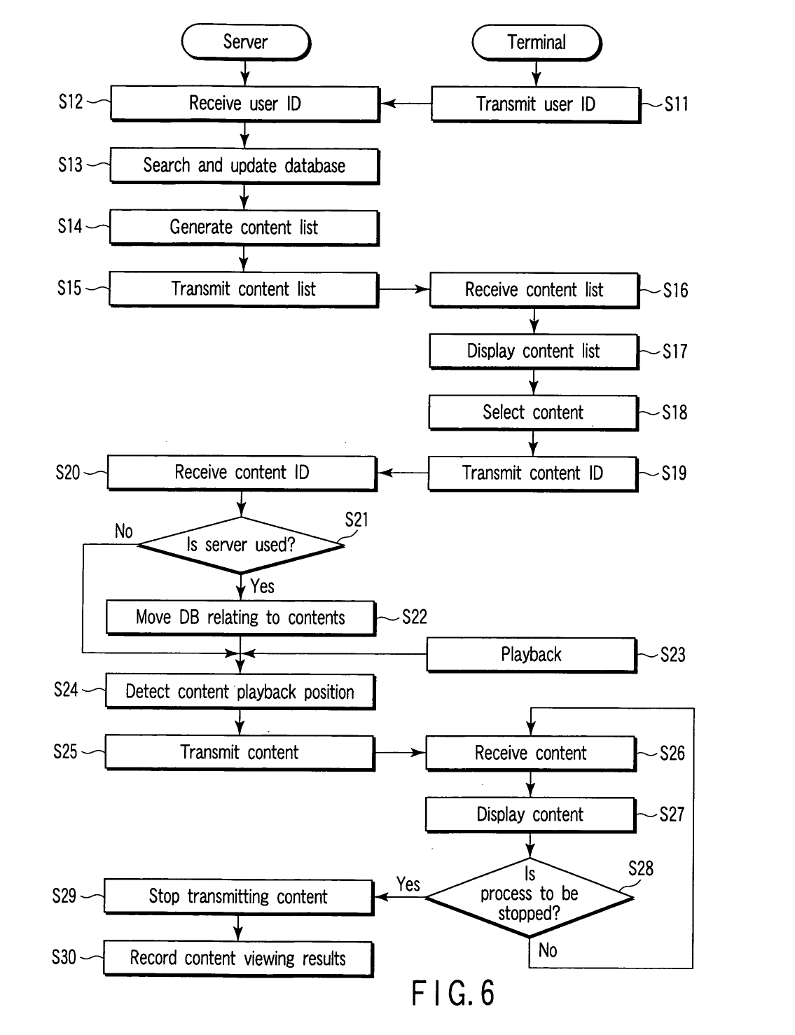

Operations of the server and terminal in this system will now be described with reference to FIG. 6. In the description, it is assumed that, for example, a user operates the terminal 11 and requests content transmission, and the content is transmitted from the server 1 to the terminal 11.

First, the terminal 11 transmits the user ID to the server in accordance with the operation by the user (block S11). The terminal 11 may be configured to automatically transmit a specific user ID registered in advance when the terminal is powered on, or to transmit the user ID corresponding to an image selected by the user from the log-in screen.

When the server 1 receives the user ID transmitted from the terminal 11 (block S12), it searches for IDs of contents (contents which the user has not completely viewed and the user is authorized to view), and updates the databases, which have old information, based on the times when the respective databases have been updated (block S13). The processes in this block are performed on the basis of the user ID, and the user information DBs 107, the content information DBs 108 and the content viewing results DBs 109 of all servers connected to the home network 21.

The server 1 generates a list of the contents, which the user can view, based on the content IDs searched in block S13 (block S14), and transmits the content list to the terminal 11 (block S15).

The terminal 11 receives the content list transmitted from the server 1 (block S16), and displays the content list on the screen (block S17). In this case, for example, a list or thumbnail is adopted as a display style.

When the user selects a content, which he/she wishes to view from the content list (block S18), the terminal 11 transmits the ID of the selected content to the server (block S19).

When the server 1 receives the content ID transmitted from the terminal 11 (block S20), it searches for a server which stores the content corresponding to the received content ID, and determines whether or not the server is used by another user (block S21).

In the determination of block S21, if the server is used by another user, the content and the databases relating to the content (the user information DB, the content information DB and the content viewing results DB) are all moved to a free server (a server which is not used) (block S22).

On the side of the terminal 11, when the user inputs a content playback start instruction, the terminal 11 transmits an instruction to playback the content (block S23).

When the server 1 receives the content playback instruction, it refers to the content viewing results DB 109 and detects the playback start position in the content requested by the user (block S24).

While decoding the content from the playback start position detected in block S24 as a starting point, the server 1 transmits the decoded content (block S25).

When the terminal 11 receives the content transmitted from the server 1 (block S26), it displays the received content on the screen (block S27).

Until the user performs a stop process, the terminal 11 repeats the process of receiving and displaying (playing back) the content in blocks S25 to S27 (block S28).

When the user inputs a content playback stop instruction, the terminal 11 transmits the instruction to the server 1. As a result, the server 1 stops the process of transmitting the content (block S29).

The server 1 records the position at which the content transmission is stopped in the content viewing results database (block S30). This information is used as playback start position information next time a playback instruction is given.

The above embodiment may be modified variously as described below.

In the above embodiment, if the server is used by another user in the determination in block S21, the content and the databases related to the content are all moved to a free server. They may be stored in the HDD of the free server, but may not necessarily be stored therein. In other words, the free server may execute only the process of decoding the content, without storing the content itself.

The databases of a copy-once content recorded in an HDD or the like (the user information DB, the content information DB and the content viewing results DB) may be stored only in one server for each content ID (that is, if the server is to be changed, copy may be disabled and only move may be enabled).

The databases may be updated in the timing when the corresponding server is connected to the home network 21. Alternatively, the databases of all servers may be reviewed and updated when one database is updated.

If a plurality of servers contain the same content and an instruction for deleting the content is given to a specific server, the ID information on the content in the content information DB 108 may not be deleted and the information indicative of “to be deleted” and the update time may be maintained. In this case, the content in another server, which is not connected to the network at that time, can be deleted later.

The user information DB 107 may be managed by only one server (main server). In this case, the main server is assumed to be always connected to the home network 21.

In addition to the parental control information to inhibit a child from viewing employed as “attribute” information, control information to permit only a specified user to view a content may be employed. In this case, the content can be kept secret to only the specified user.

In the case where a content is recorded in the HDD or the like, automatic deletion of the entity of the content may be designated in advance, when all users who have the access rights have completely viewed the content or an instruction for deletion has been executed.

“Deletion disabled (permanent storage)” information may be designated in advance as “attribute” information in the content information DB 108. Further, the content viewing results DB 109 may be configured to additionally include a function of transmitting information to ask the user whether to change “deletion enabled/disabled” information to “deletion enabled” upon completion of the viewing. As a result, a specified content may be permanently stored and the content can be prevented from being unintentionally deleted.

As a method for recognizing the user who is going to log in, the above embodiment employs the recognition based on the user ID designated through the log-in screen. Alternatively, recognition based on information input through a personal cellular phone or specific remote controller may be employed. Furthermore, a user selection button may be provided on the remote controller, so that the user can be recognized on the basis of the information corresponding to the selected button.

As described above, according to the embodiment of the invention, proper content management can be carried out in an environment where a plurality of users view contents in common. For example, if a user stops viewing a content at some midpoint and then requests view of the same content, the viewing can be restarted at the point where it was stopped.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information managing apparatus capable of delivering, to a terminal, stream data of a content which a plurality of users view in common, the apparatus comprising:
a content viewing results storage portion to store content viewing results information indicative of temporal positions in content playback at which respective users have lastly viewed the content; and
a content transmitting portion to transmit, upon a request for viewing of the content from one of the users, stream data of the content to be played back from a temporal position at which the one of the users has lastly viewed, based on the content viewing results information stored in the content viewing results storage portion.

2. The information managing apparatus according to claim 1, wherein the content viewing results storage portion further stores deletion enabled/disabled information indicative of whether each of the users permits deletion of the content, and the apparatus further comprising a processing portion to delete the content, when the deletion enabled/disabled information indicates that all of the users permit deletion of the content.

3. The information managing apparatus according to claim 2, wherein when a user completes view of the content or instructs deletion of the content, the deletion enabled/disabled information indicates that the user permits deletion of the content.

4. The information managing apparatus according to claim 3, further comprising a processing portion to cause display of information asking a user to confirm whether to delete the content, when the user completes view of the content or instructs deletion of the content.

5. An information managing method applied to an information managing apparatus capable of delivering, to a terminal, stream data of a content which a plurality of users view in common, the method comprising:
storing, in a storage portion, content viewing results information indicative of temporal positions in content playback at which respective users have lastly viewed the content; and
transmitting, upon a request for viewing of the content from one of the users, stream data of the content to be played back from a temporal position at which the one of the users has lastly viewed, based on the content viewing results information stored in the storage portion.

6. The information managing method according to claim 5, further comprising:
storing deletion enabled/disabled information indicative of whether each of the users permits deletion of the content; and
deleting the content, when the deletion enabled/disabled information indicates that all of the users permit deletion of the content.

7. The information managing method according to claim 6, wherein when a user completes view of the content or instructs deletion of the content, the deletion enabled/disabled information indicates that the user permits deletion of the content.

8. The information managing method according to claim 7, further comprising causing display of information asking a user to confirm whether to delete the content, when the user completes view of the content or instructs deletion of the content.

9. An information managing system, comprising:
a terminal; and
an information managing apparatus capable of delivering, to the terminal, stream data of a content which a plurality of users view in common;
the terminal including:
a transmission processing portion to send a request for transmission of a content to the information managing apparatus; and
a playback processing portion to play back the content transmitted from the information managing apparatus in reply to the request for transmission, and
the information managing apparatus including:
a content viewing results storage portion to store content viewing results information indicative of temporal positions in content playback at which respective users have lastly viewed the content; and
a content transmitting portion to transmit, upon a request for viewing of the content from one of the users, stream data of the content to be played back from a temporal position at which the one of the users has lastly viewed, based on the content viewing results information stored in the content viewing results storage portion.
